(19) United States
(12) Patent Application Publication
(10) Pub. No.: US 2018/0225779 A1
(43) Pub. Date: Aug. 9, 2018

(54) SYSTEM AND METHOD FOR DETERMINING POWER PRODUCTION IN AN ELECTRICAL POWER GRID

(71) Applicant: FORESIGHT ENERGY LTD, Hod HaSharon (IL)

(72) Inventors: Emek SADOT, Ram-On (IL); Evgeny FINKEL, Petah-Tikva (IL); Sergei EDELSTEIN, Herzliya (IL); Alla VOLKOV, Netanya (IL)

(73) Assignee: FORESIGHT ENERGY LTD, Hod HaSharon (IL)

(21) Appl. No.: 15/890,358

(22) Filed: Feb. 7, 2018

Related U.S. Application Data
(60) Provisional application No. 62/455,611, filed on Feb. 7, 2017.

(51) Int. Cl. G06Q 50/06; G06Q 30/02

(52) U.S. Cl. CPC G06Q 50/06; G06Q 30/0202

(57) ABSTRACT

Systems and methods of determining power production in an electrical power grid, with receiving of weather data for a geographical area, wherein the weather data includes values corresponding to prospective production of power from a renewable energy source, collecting power consumption data for consumers of an electrical power grid in the geographical area, identifying at least one consumer having an inverse relationship between the collected power consumption data and received weather data, assigning a power production value to the identified consumers, based on a comparison between the collected power consumption data and received weather data, determining total power production in the electrical power grid for all identified consumers, comparing power consumption data to the received weather data, and determining type of renewable energy source based on a correlation between power consumption and weather data for the same time period.

### FIELD OF THE INVENTION

The present invention relates to electrical power grids. More particularly, the present invention relates to systems and methods for determination and forecasting of power production in an electrical power grid.

### BACKGROUND OF THE INVENTION

In recent years, power consumption data has become available to providers (e.g. power plants) utilizing “smart” power consumption meters. These power consumption meters are usually directly coupled to a consumer, for instance coupled to a power grid of a private household, such that the power provider may at any time retrieve data from the meters, for instance retrieve power consumption data via a communication network.

While a vast amount of power consumption data is available, there is still a need for a way to manage all of this data to determine power consumption and power production in electrical power grids.

### SUMMARY OF THE INVENTION

There is thus provided, in accordance with some embodiments of the invention, a method of determining power production in an electrical power grid, the method including receiving, by a processor, weather data for a geographical area, wherein the weather data includes values corresponding to prospective production of electrical power from a renewable energy source; collecting, by the processor, power consumption data for consumers of an electrical power grid in the geographical area; identifying, by the processor, at least one consumer having an inverse relationship between the collected power consumption data and the received weather data; assigning, by the processor, a power production value to the identified consumers, based on a comparison between the collected power consumption data and the received weather data; determining total power production in the electrical power grid for all identified consumers; comparing the power consumption data to the received weather data; and determining the type of renewable energy source based on a correlation between power consumption and weather data for the same time period.

In some embodiments, the energy saving recommendations may be provided based on the power production value. In some embodiments, the energy saving recommendations may be based on weather data forecast. In some embodiments, the energy saving recommendations may be based on at least one of socio-economic status and average power consumption values for a group of consumers in a predefined geographical area. In some embodiments, the energy saving recommendations may be based on at least one of records of past power consumption, peak power consumption, and electrical power rates. In some embodiments, the energy saving recommendations may include recommendations to install a power production system.

In some embodiments, the identification of consumers may be based on correlation between weather data to the geographical location of the consumer relative to the electrical power grid. In some embodiments, the collected power consumption data may be received from at least one smart meter associated with at least one consumer.

There is thus provided, in accordance with some embodiments of the invention, a system for determination of power production in an electrical power grid, the system including a first database including power consumption data for at least one consumer of an electrical power grid, a second database including weather data for a geographical area corresponding to the electrical power grid, and a processor, operationally coupled to the first database and to the second database. In some embodiments, the processor may be configured to identify at least one consumer having an inverse relationship between the power consumption data and the weather data.

In some embodiments, the first database may include information regarding at least one of socio-economic status and average power consumption values for a group of consumers in a predefined geographical area. In some embodiments, the second database may include weather data forecast. In some embodiments, the weather data may include values corresponding to prospective production of electrical power from a renewable energy source. In some embodiments, power consumption data from consumers may be received from one or more smart meter associated with the at least one consumer.

In some embodiments, the system may further include a memory unit to store at least on of weather data and power consumption data. In some embodiments, the system may further include a renewable energy source database including types of renewable energy sources.

There is thus provided, in accordance with some embodiments of the invention, a method of forecasting power production in an electrical power grid, the method including collecting, by a processor, power consumption data for consumers of an electrical power grid in a geographical area, with corresponding weather data including values corresponding to prospective production of electrical power from a renewable energy source; detecting, by the processor, at least one consumer having an inverse relationship between the collected power consumption data and a parameter in the weather data; determining power production in the electrical power grid for each identified consumer; and determining, by the processor, power production forecast based on a correlation between power consumption and a parameter in weather data for the same time period.

In some embodiments, energy saving recommendations may be provided based on the power production value. In some embodiments, energy saving recommendations may be based on at least one of records of past power consumption, peak power consumption, and electrical power rates. In some embodiments, the energy saving recommendations may include recommendations to install a power production system. In some embodiments, calculation of power production forecasting may be based on aggregation of consumption and production in each geographical location of the consumer relative to the electrical power grid.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 schematically illustrates a system for determination of power production in an electrical power grid, according to some embodiments of the invention;

FIG. 3A shows a flowchart of a method of determining power production in an electrical power grid, according to some embodiments of the invention; and

FIG. 3B shows a continuation of the flowchart from FIG. 3A, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

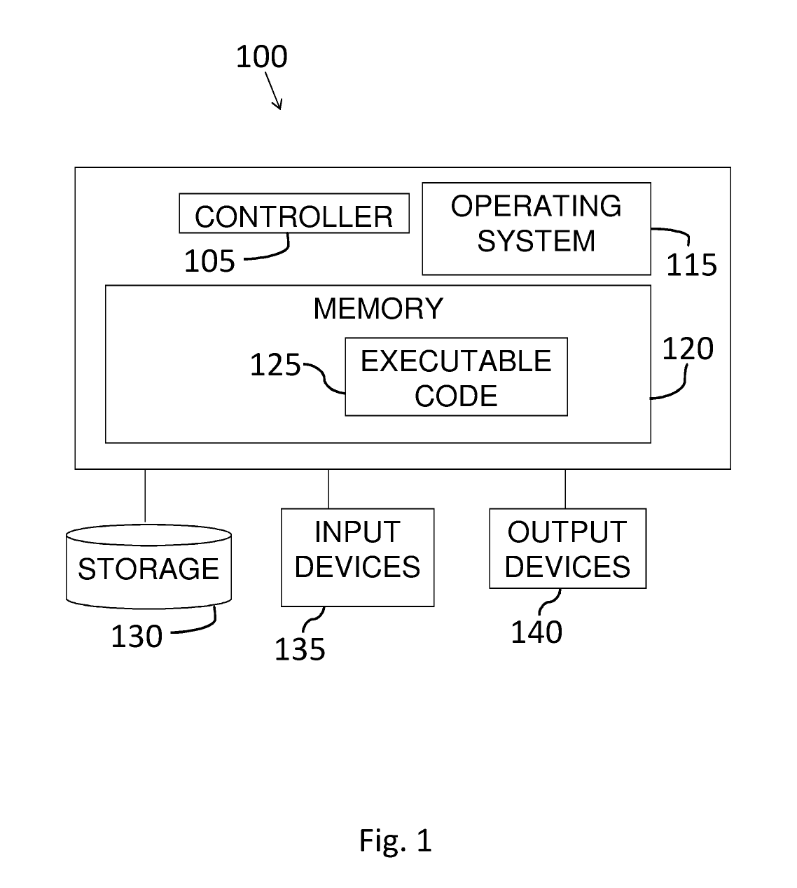

Reference is made to FIG. 1, showing a block diagram of an exemplary computing device, according to some embodiments of the present invention. Computing device 100 may include a controller 105 that may be, for example, a central processing unit processor (CPU), a chip or any suitable computing or computational device, an operating system 115, a memory 120, a storage 130, an input devices 135 and an output devices 140. Controller 105 may be configured to carry out methods as disclosed herein by for example executing code or software.

Operating system 115 may be or may include any code segment designed and/or configured to perform tasks involving coordination, scheduling, arbitration, supervising, controlling or otherwise managing operation of computing device 100, for example, scheduling execution of programs. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Executable code 125 may be any executable code, e.g., an application, a program, a process, task or script. Executable code 125 may be executed by controller 105 possibly under control of operating system 115. For example, executable code 125 may be an application for managing power consumption data. Where applicable, executable code 125 may carry out operations described herein in real-time. Computing device 100 and executable code 125 may be configured to update, process and/or act upon information at the same rate the information, or a relevant event, are received. In some embodiments, more than one computing device 100 may be used. For example, a plurality of computing devices that include components similar to those included in computing device 100 may be connected to a network and used as a system. For example, managing power consumption data may be performed in real time by executable code 125 when executed on one or more computing devices such computing device 100.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a modem, printer or facsimile machine, a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, cause the processor to carry out methods disclosed herein. For example, some embodiments of the invention may include a storage medium such as memory 120, computer-executable instructions such as executable code 125 and a controller such as controller 105.

A computer or processor non-transitory storage medium, may include for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

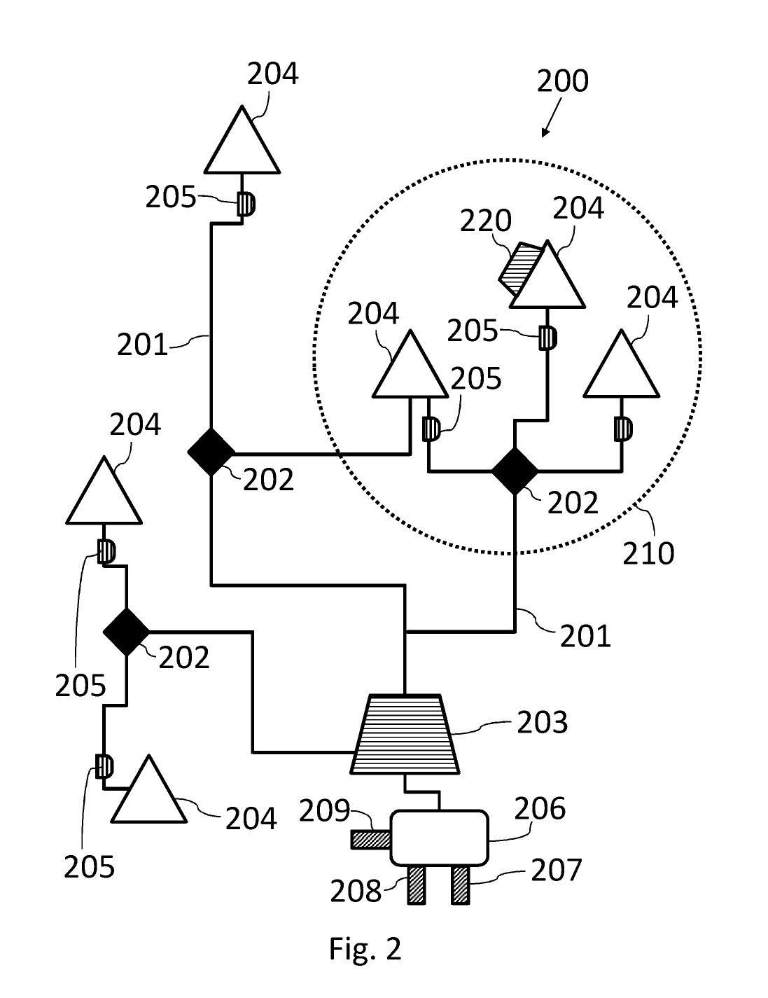

Reference is now made to FIG. 2, which schematically illustrates a system 200 for determination and forecasting of power production in an electrical power grid 201, according to some embodiments of the invention. In some embodiments, it may be possible to detect which consumers produce power by correlating historical data on consumed energy from the electrical power grid, by reducing the produced energy from the total consumed energy, as further described hereinafter.

Power production determination system 200 may include an electrical power grid 201 with a plurality of electrical power nodes 202 (or electrical power transformation centers) that receive power from a central electrical power distributor 203. Each electrical power node 202 may be configured to provide electrical power, via electrical power grid 201, to at least one consumer 204 (e.g., a private household or an office building). Power distributer 203 (e.g., a local power plant) may distribute electrical power, via electrical power grid 201, to electrical power nodes 202 and thereby to consumers 204.

According to some embodiments, electrical power grid 201 may have (e.g., smart) power consumption meters 205, which measure power consumption of at least one consumer 204 that is coupled thereto, so as to allow monitoring of the power consumption of consumers 204. In some embodiments, power consumption meters 205 may also be configured to allow communication with at least one analysis computerized device 206 (or central processor), for instance operably coupled to power distributer 203.

In some embodiments, computerized device (or processor) 206 may be a computing device 100 (such as shown in FIG. 1) with corresponding processing and memory elements configured to allow analyzing and processing of aggregated data from all consumers 204. It should be appreciated that via the coupling to power distributer 203, the analysis computerized device 206 may be operationally coupled to at least two electrical power nodes 202.

It should be appreciated that communication with computerized device 206 may be carried out via a wireless network and/or via communication cables (for instance adjacent to electrical power grid 201). In some embodiments, different power consumption meters 205 may communicate with computerized device 206 via different networks, for instance a wired network and a cellular network.

According to some embodiments, power production determination system 200 may include a dedicated power consumption database 207, operably coupled to computerized device 206, including data for at least one consumer 204. In some embodiments, each consumer 204 may have a user profile indicating typical power consumption of that user, for instance based on previous power consumption records from power consumption database 207. Thus, data received for that consumer 204 (e.g., from consumption meters 205) may be compared to the user profile in order to detect changes in power consumption. In some embodiments, power consumption database 207 may also have information with calendar data, for example, where people on national holiday for instance may use more electrical devices compared to weekdays where people are usually at work during the day. In some embodiments, calendar data may be stored in a separate dedicated database.

In some embodiments, each consumer 204 may have a user profile with selected dates (e.g., selected days) of the calendar data where power consumption and/or power production is expected to be significantly different. For example, a consumer 204 may select a specific date expecting low power production (e.g., due to infrastructure maintenance) or high power consumption (e.g., due to a party with many people in the same household) such that power recommendations may be accordingly modified.

In some embodiments, power production determination system 200 may further include a dedicated ambient condition database 208 and a renewable energy source database 209, operably coupled to computerized device 206. For example, on a cold day, more heaters may be turned on, thereby increasing overall power consumption. Ambient condition database 208 may include information for weather conditions in a predefined geographical area 210 (indicated with a dashed line) corresponding to the electrical power grid 201. In some embodiments, weather data from ambient condition database 208 may include values corresponding to prospective or future production of electrical power from a renewable energy source. For example, specific solar illumination intensity may correspond to a known power production with solar panels (e.g., determined during calibration). In some embodiments, ambient condition database 208 may further include information for a weather forecast. In some embodiments, ambient condition database 208 may further include information regarding physical properties of the consumer 204, for example available space to install a solar panel and/or a wind turbine 220.

It should be appreciated that, in an area having smart power consumption meters within a predetermined geographical zone (e.g., determined for each central electrical power distributor 203), neighboring consumers may present similar power consumption behavior (e.g. for families from similar socio-economic levels), such that these consumers may be grouped based on their power consumption, for instance grouped within a street, a portion of a street, a neighborhood or even within a city.

Renewable energy source database 209 may include information for various types of systems 220 for power production from renewable energy sources, such as solar panels, wind turbines, etc. In some embodiments, renewable energy source database 209 may further include typical power production values for each type, for example typical power production values for a solar panel 220 for a particular geographical area 210 having clear skies enabling full illumination of the panels (e.g., data from a calibrated external source).

In some embodiments, all meters in electrical power grid may be sampled in order to identify a source of nearly pure production 220 where power consumption is minimal, in order to forecast power production of such a system 220 in the future. For example, power production determination system 200 may include a solar panel 220 that may produce power in an empty household 204 where no one consumes power from the electrical power grid, as a source of nearly pure production 220. It may, therefore, be possible to provide recommendations of installing a similar power production system 220 (knowing possible power production for such a system) to consumers 204 having similar conditions (e.g., being in the same geographical area 210, having similar physical characteristics and the like).

According to some embodiments, computerized device 206 may identify at least one consumer having an inverse relationship between the power consumption data (from power consumption database 207) and the weather data (from ambient condition database 208). Consumers identified as having an inverse relationship may be determined to produce electrical power from renewable energy sources, with a renewable energy power production system 220.

In some embodiments, data from consumers determined to produce electrical power from renewable energy sources may be compared to data from renewable energy source database 209 so as to determine at least one type of renewable energy source used to produce the power. For example, computerized device 206 may determine that a particular consumer has solar panels and/or a wind turbine to produce electrical power.

In some embodiments, consumers 204 identified as having a power production system 220 may receive recommendation to install an additional power production system 220 in order to increase the power production. For example, a consumer 204 having a wind turbine may receive recommendations to install a solar panel and/or an additional wind turbine to increase the power production.

In some embodiments, power consumption for consumers 204 identified as having a power production system 220 may be further analyzed (e.g., by computerized device 206) to identify a reduction in power production with time (e.g., due to dust collected on a solar panel). Upon detection of such a reduction in power production with time, system 200 may provide maintenance recommendation to the consumer 204.

In some embodiments, computerized device 206 may associate power consumption data for a particular consumer 204 to similar consumers, by comparison to other consumers so as to allow prediction of expected power production (e.g., from power consumption database 207) at a similar period of time, for example in a previous month, prior to suspected installation of power generator (e.g., a solar panel). In some embodiments, computerized device 206 may associate and/or cluster consumer power consumption data with consumption data of other similar consumers 204, based on at least one of the following parameters: being in the same geographical area 210 and/or having similar socio-economic state and/or having similar average power consumption during the hours when generation from renewable sources is ineffective (e.g., during night for solar panels).

In some embodiments, false identification of consumers 204 having power production systems 220, may be reduced by correlating power production to actual ambient conditions (such as illumination or wind conditions). In some embodiments, false identification of consumers 204 having power production systems 220, may be reduced by comparison to other consumers 204 in a benchmark group and/or comparison to previous power consumption in a previous time period (e.g., prior to identification of a power production system).

According to some embodiments, the power production determination system 200 may allow automatic identification of candidates for power production based on at least one of recorded consumption patterns, geographical conditions and roof prerequisites, for instance while applying machine learning algorithms. In some embodiments, power production determination system 200 may dynamically segment consumers 204 to identify behavior patterns so as to optimize forecasting of power production and/or forecasting of power consumption, for example computerized device 206 may disintegrate consumption to base load, weather dependent and flexible load and analyze correlations thereof. In some embodiments, geographical aggregation of power production and/or power consumption may be applied to determine net load in each geographical point.

It should be noted that in comparison to typical solutions that are based on statistical estimates of power production or consumption in each season of the year, the power production determination system 200 may allow dynamic point-by-point analysis of end-user historical and/or forecasted power consumption and/or historical and/or forecasted power production in order to generate accurate recommendations for installation of a power production system. Moreover, the generated recommendations may be applied on a set of locations where no existing power production facilities were identified, for example provide recommendations for a consumer without a power production facility to install such facility in a predetermined location (e.g., on the roof).

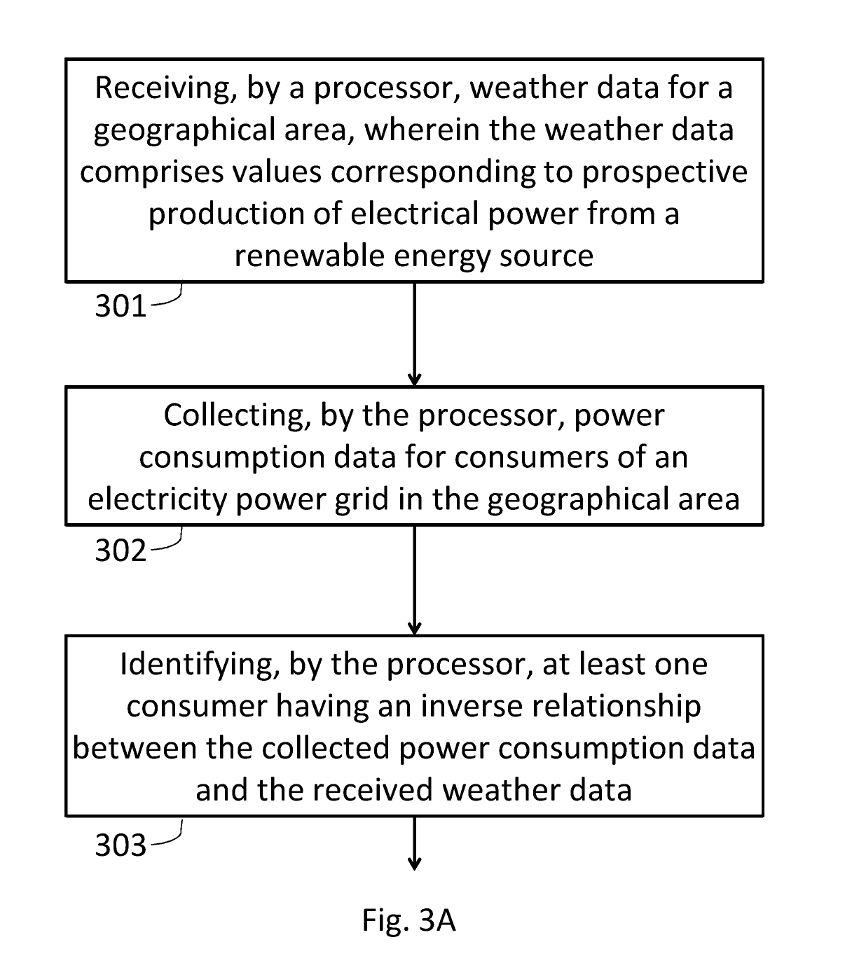

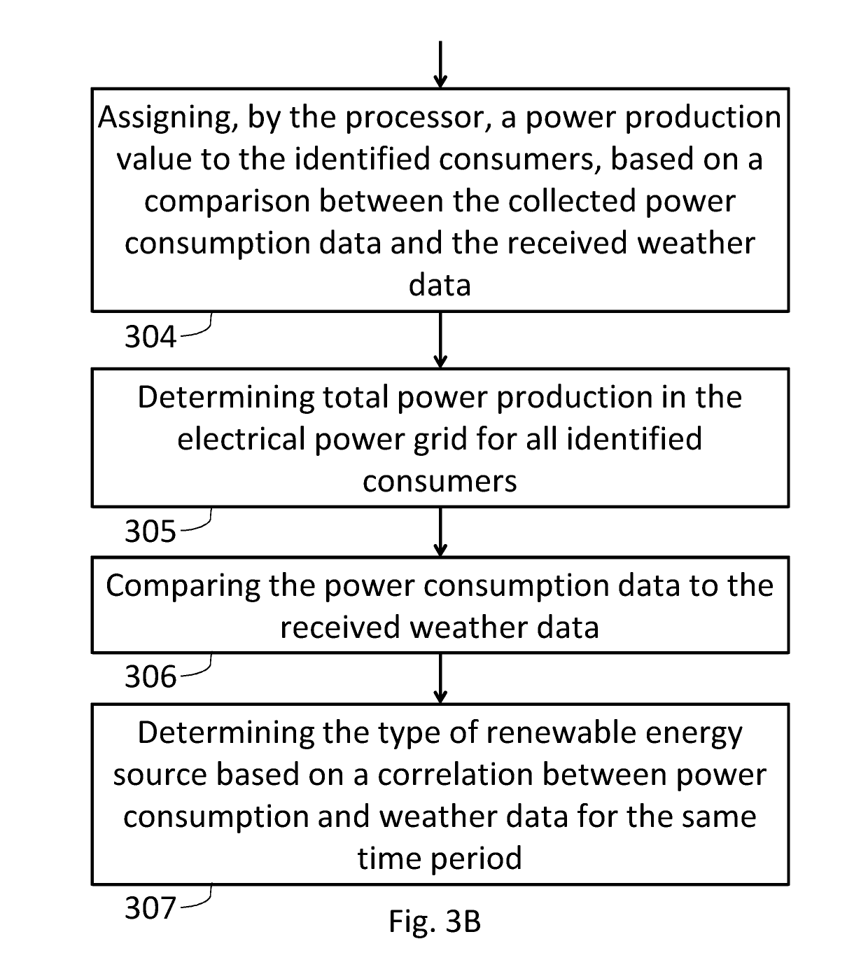

Reference is now made to FIGS. 3A and 3B, which show a flowchart of a method of determining power production in an electrical power grid, according to some embodiments of the invention. Some embodiments may include receiving or collecting 301, by the processor 206, weather data for a predetermined geographical area 210 such that this area only includes consumers 204 of interest, wherein the weather data includes weather values such as temperature, solar illumination intensity, wind speed, pressure, rain amount, where the weather values correspond to values prospective or future production of electrical power from a renewable energy source (e.g., stored in a separate database), for example specific solar illumination intensity may correspond to a known power production with solar panels (e.g., determined during calibration).

Some embodiments may include receiving or collecting 302, by the processor 206, power consumption data for consumers 204 of an electrical power grid 201 in the predetermined geographical area 210. Some embodiments may include collecting data for at least one consumer 204 of the electrical power grid 201. For example, the collected data may include a received electrical power grid layout (or topology) and consumer 204 data. For example, data may be collected (e.g., from smart meters) to determine which consumer 204 is coupled to which power node 202 where the determination (of which consumer 204 is coupled to which power node 202) may be based on consumer parameters such as geographical position and social value.

In some embodiments, the collected data may have information regarding at least one of weather conditions at a predefined geographical area (e.g. a city), socio-economic status of consumers in the area, power consumption data for the one or more consumers in the area, and average power consumption values for a group of consumers in the predefined geographical area.

Some embodiments may include identifying 303, by the processor 206, at least one consumer 204 having an inverse relationship between the collected power consumption data and the received weather data. For example, one embodiment may detect a decrease in power consumption (e.g., collected from a smart meter) at a time of high solar illumination conditions. In some embodiments, the identification of consumers 204 may include associating each consumer 204 to a consumption group, according to one or more attributes of each consumer 204, wherein at least one consumer 204 in each group may be connected to a smart meter. In some embodiments, the identification of consumers 204 may include comparing power consumption data for a particular consumer at different time periods.

Some embodiments may include assigning 304, by the processor 206, a power production value (e.g., a general unit-less value) to identified consumers 204 as an indicator of power production, based on a comparison between the collected power consumption data and the received weather data. Some embodiments may include determining 305 total power production in the electrical power grid 201 for all identified consumers 204.

Some embodiments may include comparing 306 the power consumption data to the received weather data. Some embodiments may include determining 307 the type of renewable energy source based on a correlation between power consumption and weather data for the same time period.

Some embodiments may include providing energy saving recommendations based on the power production value. In some embodiments, the energy saving recommendations may also be based on weather data forecast, for example recommend operating devices with high power consumption (e.g., washing machine) during time periods of potentially high power production from a renewable energy source (e.g., during high illumination time periods for solar panels). In some embodiments, the energy saving recommendations may also be based on at least one of socio-economic status and average power consumption values for a group of consumers in a predefined geographical area. In some embodiments, the energy saving recommendations may also be based on records of past power consumption and/or peak power consumption and/or electrical power rates.

In some embodiments, the energy saving recommendations may also be based on analysis of current power consumption, with forecasting of future power production, and providing a recommendation to install a power production system. For example, processor 206 may identify a consumer with time periods of high illumination (e.g., for a solar panel) and/or strong winds (e.g., for a wind turbine) and recommending to install a suitable power production system.

Some embodiments may include comparing the power consumption data to the received weather data, and determining the type of renewable energy source based on correlation between power consumption and weather data for the same time period. For example, an embodiment may receive power consumption data from a calibrated external power source (e.g., a solar panel with known power production for specific illumination values) to determine a renewable energy source type that is compatible with the measured weather data. In some embodiments, the identification of consumers may be based on correlation between weather data to the geographical location of the consumer relative to the electrical power grid. As may be apparent to one of ordinary skill in the art, such determination of renewable energy source type may in some embodiments not require previous knowledge of existing systems allowing power production from renewable energy sources, for instance in the predetermined geographical area 210.

Some embodiments may include storing at least one of weather data and power consumption data on a memory unit. In some embodiments, the collected power consumption data may be received from at least one smart meter 205 associated with at least one consumer 204. Some embodiments of the present invention may allow consumers in a power grid with renewable energy power sources to be identified, such that recommendation for power consumption optimization may be created based on the types of the renewable energy sources, and thereby save power compared to existing methods where such recommendations cannot be created.

Unless explicitly stated, the method embodiments described herein are not constrained to a particular order in time or chronological sequence. Additionally, some of the described method elements can be skipped, or they can be repeated, during a sequence of operations of a method.

Various embodiments have been presented. Each of these embodiments may of course include features from other embodiments presented, and embodiments not specifically described may include various features described herein.

1. A method of determining power production in an electrical power grid, the method comprising:
receiving, by a processor, weather data for a geographical area, wherein the weather data comprises values corresponding to prospective production of electrical power from a renewable energy source;
collecting, by the processor, power consumption data for consumers of an electrical power grid in the geographical area;
identifying, by the processor, at least one consumer having an inverse relationship between the collected power consumption data and the received weather data;
assigning, by the processor, a power production value to the identified consumers, based on a comparison between the collected power consumption data and the received weather data;
determining total power production in the electrical power grid for all identified consumers;
comparing the power consumption data to the received weather data; and
determining the type of renewable energy source based on a correlation between power consumption and weather data for the same time period.

2. The method of claim 1, further comprising providing energy saving recommendations based on the power production value.

3. The method of claim 2, wherein the energy saving recommendations are based on weather data forecast.

4. The method of claim 2, wherein the energy saving recommendations are based on at least one of socio-economic status and average power consumption values for a group of consumers in a predefined geographical area.

5. The method of claim 2, wherein the energy saving recommendations are based on at least one of records of past power consumption, peak power consumption, and electrical power rates.

6. The method of claim 2, wherein the energy saving recommendations comprise recommendations to install a power production system.

7. The method of claim 1, wherein the identification of consumers is based on correlation between weather data to the geographical location of the consumer relative to the electrical power grid.

8. The method of claim 1, wherein the collected power consumption data is received from at least one smart meter associated with at least one consumer.

9. A system for determination of power production in an electrical power grid, the system comprising:
a first database comprising power consumption data for at least one consumer of an electrical power grid;
a second database comprising weather data for a geographical area corresponding to the electrical power grid; and
a processor, operationally coupled to the first database and to the second database, wherein the processor is to identify at least one consumer having an inverse relationship between the power consumption data and the weather data.

10. The system of claim 9, wherein the first database comprises information regarding at least one of socio-economic status and average power consumption values for a group of consumers in a predefined geographical area.

11. The system of claim 9, wherein the second database comprises weather data forecast.

12. The system of claim 9, wherein the weather data comprises values corresponding to prospective production of electrical power from a renewable energy source.

13. The system of claim 9, wherein power consumption data from consumers is received from one or more smart meter associated with the at least one consumer.

14. The system of claim 9, further comprising a memory unit to store at least on of weather data and power consumption data.

15. The system of claim 9, further comprising a renewable energy source database comprising types of renewable energy sources.

16. A method of forecasting power production in an electrical power grid, the method comprising:
collecting, by a processor, power consumption data for consumers of an electrical power grid in a geographical area, with corresponding weather data comprising values corresponding to prospective production of electrical power from a renewable energy source;
detecting, by the processor, at least one consumer having an inverse relationship between the collected power consumption data and a parameter in the weather data;
determining power production in the electrical power grid for each identified consumer; and
determining, by the processor, power production forecast based on a correlation between power consumption and a parameter in weather data for the same time period.

17. The method of claim 16, further comprising providing energy saving recommendations based on the power production value.

18. The method of claim 17, wherein the energy saving recommendations are based on at least one of records of past power consumption, peak power consumption, and electrical power rates.

19. The method of claim 17, wherein the energy saving recommendations comprise recommendations to install a power production system.

20. The method of claim 16, wherein calculation of power production forecasting may be based on aggregation of consumption and production in each geographical location of the consumer relative to the electrical power grid.
